(19) United States
(12) Patent Application Publication
(10) Pub. No.: US 2015/0317398 A1
(43) Pub. Date: Nov. 5, 2015

(54) PRESENTING NON-SUGGESTED CONTENT ITEMS TO A USER OF A SOCIAL NETWORK ACCOUNT

(71) Applicant: Derek J. Phillips, Waterloo (CA)

(72) Inventor: Derek J. Phillips, Waterloo (CA)

(73) Assignee: Google Inc., Mountain View, CA (US)

(21) Appl. No.: 13/089,531

(22) Filed: Apr. 19, 2011

Related U.S. Application Data
(60) Provisional application No. 61/428,330, filed on Dec. 30, 2010.

(51) Int. Cl. G06F 17/30; H04L 29/06; G06F 3/048

(52) U.S. Cl. CPC G06F 17/30867; H04L 65/403; G06F 17/30598; G06F 17/3053; G06F 17/30554; G06F 17/30345

(57) ABSTRACT

Methods, systems, and apparatus, including computer programs encoded on a computer storage medium, for presenting non-suggested content items to a user of a social network account are described. In one aspect, a method includes storing social network account data indicating preferred categories of content and non-preferred categories of content associated with a particular social network account. Suggested content items corresponding to the preferred categories of content are identified, and non-suggested content items corresponding to the non-preferred categories of content are identified. A graphical user interface is provided for presentation to a user of the particular social network account. The graphical user interface presents information about the suggested content items and information about the non-suggested content items. Feedback data is received based on a user interaction in response to presentation of the information about the non-suggested content items. The stored social network account data is updated based on the feedback data.

### CROSS-REFERENCE TO RELATED APPLICATIONS

This application claims the benefit of U.S. Provisional Application Ser. No. 61/428,330, entitled “Presenting Non-Suggested Content Items to a User of a Social Network Account,” filed on Dec. 30, 2010, which is hereby incorporated by reference.

### BACKGROUND

This specification relates to presenting non-suggested content items to a user of a social network account.

Social networks allow users to publish information and communicate with other users over the Internet. Social network users typically access the social network through an account created by the user. For example, a user can create a personal account, or an account for a business, group, organization, or other entity. Users can publish information (e.g., pictures, status information, videos, links, etc.) on their account page so that other users can access the published information. Social networks may also provide access to public content items such as articles, videos, and information publicly available on the Internet. Social networks identify content recommendations that a social network user is likely to be interested in (e.g., based on content related to content items the social network user previously viewed or otherwise exhibited an interest in), and the content recommendations are presented to the user, for example, by providing links to (or previews of) the recommendations.

### SUMMARY

This specification describes technologies relating to presenting non-suggested content items to a user of a social network account. In a general aspect, users of a social network can view information on content items that are not being suggested to them. Allowing users to view and/or provide feedback on non-suggested content items may improve the social network's ability to recommend content of interest to the user, may allow the user to explore new areas of interest, and/or may allow the social network to confirm areas that the user is not interested in with greater confidence. Tailoring suggestions based on the past behavior of the user's account, similarity to other accounts, etc. may incidentally filter out suggestions that the user would be interested in. For example, the tailoring may be based on incorrect negative signals or a poor classification of the user's interests, which may incorrectly indicate a low level of interest in some types of content. Such incorrect negative signals may result from the account owner accidentally indicating a preference for content or allowing other people to use the account. Similarly, a user's interests may change over time or the user may be “out of touch” with latest trends, news, and sources of information. A mechanism that allows a user to view information about content that the suggestion system indicates the user will not be interested in may lead to a better user experience and improved social network intelligence.

In a general aspect, social network account data indicating preferred categories of content associated with a particular social network account are stored. Suggested content items corresponding to the preferred categories of content are identified. Non-preferred categories of content for the particular social network account are identified based on information associated with the social network account. Non-suggested content items corresponding to the non-preferred categories of content are identified for the particular social network account. A graphical user interface is generated for presentation at a client device to a user of the particular social network account. The graphical user interface includes a first user interface component that presents information about the suggested content items and a second user interface component that presents information about the non-suggested content items. Feedback data is received based on a detection of a user interaction with the second user interface component in response to presentation of the information about the non-suggested content items. The stored social network account data is updated based on the feedback data.

Implementations may include one or more of the following features. The stored social network account data indicates the non-preferred categories of content. The feedback data indicates an area of interest or an area of non-interest for the user of the particular social network account. Updating the stored social network account data includes storing the feedback data in a database with the stored social network data. Updating the stored social network account data includes modifying the stored social network data. Updating the stored social network account data includes providing the feedback data as input to a learning system. The user interaction includes the user giving focus to the information about the content item, the user requesting to view additional information about the content item, and/or the user dismissing the information about the content item. Available content items are ranked according to the social network account data. The suggested content items and the non-suggested content items are identified from the available content items based on the ranking One or more of the suggested content items corresponds to multiple categories of content. One or more of the available content items includes a public entry associated with a second, different social network account. The public entry includes a shared link, a photo, a video, and/or an update. The user interface solicits user feedback by presenting a plurality of interest level indicators that allow the user to indicate an interest level for one or more of the non-suggested content items. The user interaction action includes a user selection of one of the interest level indicators. A system includes a database that stores the described information and a server that performs the described operations. The system further includes the client device. The system further includes a data communication network that transmits data between the client device and the server. The client device includes a personal computer or a mobile device running a browser.

Particular embodiments of the subject matter described in this specification can be implemented so as to realize one or more of the following advantages. Presenting non-suggested content items to a social network user may provide a way for the user to learn about events or information that would otherwise be filtered from the user. Soliciting feedback from a social network user on non-suggested content items may provide a way to improve training for learning and/or classification systems. Allowing a social network user to view information and provide feedback on non-suggested content items may provide a way for the user to express interest in areas that a learning and/or classification system may have predicted would not interest the user. Such features may allow the social network to provide an improved user experience and more accurate or reliable information about the social network users. Such improved user experience may increase loyalty of the user to, or reliance by the user on, the social network. Exposing users to non-suggested content items may diversify a user's interest categories outside of the highest rated categories and/or allow established users to uncover new trends or topics they are not familiar with. In some instances, allowing users to select non-suggested content items may allow the user to obfuscate or “drown” interests in a sea of other fringe interests. In addition, exposing users to non-suggested content items may highlight and increase the reach of “niche” communities in the social network and/or encourages users to meet people from other communities they would not otherwise be exposed to. As another example, researchers, reporters, and/or others may have the opportunity to participate in a community or category for which they are not a member in order to learn about the community or category.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example social network.

FIG. 2A is a schematic diagram of an example computing system that can be used to implement aspects of a social network.

FIG. 2B is a schematic diagram of example data relating to a social network.

FIGS. 3A and 3B are diagrams of example account pages that present a graphical user interface for a particular account in a social network.

FIG. 4 is a flow chart showing an example process for allowing a user to view non-suggested content items in a social network.

Like reference numbers and designations in the various drawings indicate like elements.

### DETAILED DESCRIPTION

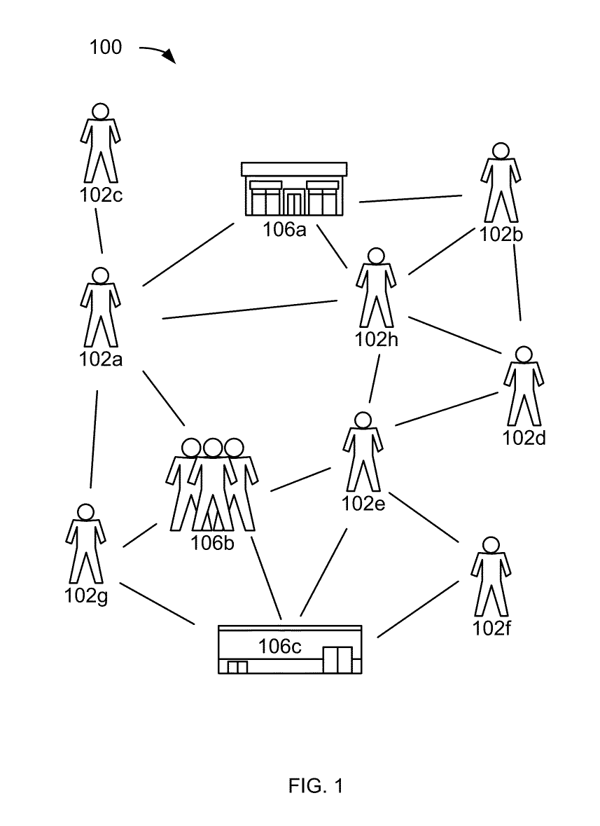

FIG. 1 is a schematic diagram of an example social network 100. Generally, the social network 100 is implemented on communication infrastructure, and users of the social network 100 communicate with each other, share and consume information, and/or otherwise interact through web servers and/or other equipment that support communications within the social network 100. A user can create a representative identity in the social network 100 by establishing a social network account. The user may then access the social network 100 by logging onto the user's social network account, for example, from an Internet-capable device. As a user consumes content and interacts with other users in the social network 100, the user can request that information relating to the user's interests and/or preferred types of content be stored or saved. Based on the user's request, such information can be stored, for example, in a database associated with the social network 100. Users can decline the option of having such information stored. The social network 100 may include a learning system or a classification system that learns about and/or categorizes the user's interests. As more information on the user's interests becomes available, content items corresponding to the user's interest may be suggested to the user. For example, if the user views the scores for a particular baseball team and the user has requested that content items be suggested based on browsing history, information on content items (e.g., news articles, videos, events, comments by other users, etc.) relating to the baseball team may be presented to the user on the user's social network account page. In some instances, the user may be given the opportunity to view information on content items that are not being suggested to the user. For example, a user's social network account page may display a message indicating that a content item relating to gardening is not being suggested to the user because the user previously indicated lack of interest in gardening. By presenting non-suggested content items, the user may have the opportunity to provide feedback that confirms areas of non-interest and/or feedback that indicates new areas of interest. Such information may improve the user's experience with the social network and allow the learning system or classification system to generate improved information about the user when the user has opted for such features.

The social network 100 may include social network accounts accessed by a regional, multi-regional, or global array of users. The social network 100 may include hundreds, thousand, millions, or even billions of social network accounts. The social network 100 may allow users to establish different types of social network accounts for different purposes. The example social network 100 includes individual accounts 102a, 102b, 102c, 102d, 102e, 102f, 102g, 102h (collectively “individual accounts 102”), organization accounts 106a, 106b, 106c (collectively “organization accounts 106”), and possibly other types of accounts (not shown). The schematic diagram in FIG. 1 corresponds to a social graph that represents the accounts and connections between the accounts in the social network 100.

For situations in which the systems discussed here collect personal information about users, the users may be notified and/or provided with an opportunity to opt in/out of and/or disable programs or features that may collect personal information (e.g., information about a user's preferences, demographic information, social network interactions, browsing history, etc.). In addition, certain data may be anonymized in one or more ways before it is stored or used, so that personally identifiable information is removed. For example, a user's identity may be anonymized so any identified user preferences or user interactions are generalized rather than associated with a particular user.

The individual accounts 102 are social network accounts that each represent the identity (actual or assumed) of an individual user on the social network 100. For example, each of the individual accounts 102 may be the personal account for an individual person. The organization accounts 106 are social network accounts that each represent the identity of a group, an organization, and/or another type of entity on the social network 100. The organization accounts 106 may represent, for example, businesses, charities, clubs, events, distribution lists, and/or other types of organizations. For example, organization account 106a is an account for small businesses (e.g., a retailer, a firm, a manufacturer, etc.), organization account 106b is an account for a group of people (e.g., a committee, a club, etc.), and organization account 106c is an account for a corporation (e.g., an international business entity).

In FIG. 1, the lines between the accounts represent connections in the social network 100. For example, the individual account 102a has five connections: connections with accounts 102c, 106a, 102h, 106b, and 102g; and the individual account 102h has five connections: connections with accounts 102b, 102d, 102e, 102a, and 106a. An account may generally have connections with any number (e.g., tens, hundreds, thousand, millions, etc.) of accounts. Connections between social network accounts may be created in a number of different ways and/or based on a number of different factors. Moreover, the social network may define multiple different types of connections that can be established. For example, one type of connection may indicate that two social network accounts share a “friend” status, another type of connection may indicate that a social network account is a “follower” of another social network account, or another type of connection may indicate that two social network accounts are “linked,” and other types of connections may be defined. Connections may include bidirectional connections, unidirectional connections, and/or other types of connections. A bidirectional connection between two accounts indicates that the two accounts each have a connection to the other account. A unidirectional connection between two accounts indicates that a first account has a connection to another account, where the other account may or may not have a connection to the first account.

As information is posted (e.g., published, uploaded, or entered) to the social network accounts by the users of the accounts, the posted information may be available to users of one or more of the other accounts in the social network 100. The information may include status updates, photos, videos, messages, links, and/or other types of content items. In some instances, the information posted by an account is only viewable by certain other accounts. For example, a user of the individual account 102a may want only her individual account neighbors to have access to information posted on her social network account page. In such a case, only the individual accounts 102c, 102h, 102g that have connections to the individual account 102a would have access to the information posted by the individual account 102a. As another example, a user of the organization account 106a may want all accounts to have access to information posted on her social network account page. In such a case, all accounts in the social network 100 would have access to the information posted by the organization account 106a.

In addition to the information posted to the social network accounts, other information may be available to users of the social network 100. For example, a user's account page may provide access to Internet content, content generated for the social network 100, and/or other types of content. Such content may include articles, news, videos, blogs, photos, and/or other types of content. In some implementations, users may access Internet content, social network content, and/or other types of content through the social network infrastructure, for example, by logging into their social network accounts and following links displayed on their social network account pages.

With such a large amount of content generally available to users of the social network, many users may find it helpful or efficient to have particular content items suggested to them in an automated manner based on filtering criteria. Users may request that the content items be selected, prioritized and/or otherwise customized for the individual user and presented in the user's social network account page. For example, the social network infrastructure may include one or more databases that stores information about users who have given permission to store such information, a classification server that identifies and/or categorizes the interest of each user based on the stored information, and a suggestion server that identifies particular content items to suggest to individual users based on the individual user's interests. The suggested content items may include status updates, photos, videos, messages, links, articles, news snippets, and/or other types of content items, which may include content items posted by other users of the social network, Internet content, and/or other content from other types of sources. For example, if the information about a product sale is posted to the organization account 106a, a link to the information may be suggested to the individual accounts 102a, 102h, 102b having connections to the organization account 106a. As another example, if the user of the individual account 102a frequently views stock quotes for a particular stock, a link to an Internet article about the particular stock may be suggested to the user of the individual account 102a. Alternatively, users may opt out of receiving personalize suggestions.

The suggested content items are typically only a small subset of the available content items. Thus, there are typically many available content items that are not suggested to an individual user. In some implementations, users of the social network 100 are given the option to view one or more of the non-suggested content items. For example, a user's social network account page may include a module that the user can select to view a sampling of non-suggested content items. The non-suggested content items may include content items corresponding to content categories that the user has indicated he or she is not interested in (or that the social network servers have deduced the user is not interested in). As such, existing information about a social network account may include negative indicators for one or more of the non-suggested content items. One or more of the non-suggested content items may have been filtered from the available content items based on such negative indicators.

Information about the non-suggested content items may be displayed to the user, for example, upon request by the user, or independent of a user request. A preview of, a link to, and/or other information about the non-suggested content items may be displayed in a separate module from the suggested content items so that the user can distinguish suggested and non-suggested content items. Thus, the user may be presented a list of items that have been filtered from the available content items (and thus not suggested) based on negative indicators associated with the user's social network account.

The user may be given the opportunity to indicate an interest level in the non-suggested content item. For example, the user may be given the opportunity to confirm lack of interest in the non-suggested content item or to indicate interest in the non-suggested content item. Feedback on the non-suggested content items may be actively solicited from the user. For example, one or more of the non-suggested content items may be presented with a prompt or an interface that allows a user to indicate the user's level of interest in the non-suggested content item. In some instances, feedback may be collected based on user interactions without any active solicitation of feedback. For example, the feedback may be based on the user requesting more information and/or the user viewing one or more of the non-suggested content items in response to the presentation of information about the non-suggested content item. Users may opt out of having such feedback collected or stored.

In one aspect of operation, users create social network accounts in the social network 100. For example, a person may set up the individual account 102a as her personal account, and a manager of a retail store may set up the organization account 106a for the retail store, etc. A database stores information on each of the social network accounts. For example, user's may request that the database store demographic information about the users, information relating to the user's interests, information that identifies social network account connections, and/or other types of information. Over time, as the social network accounts are used, information on areas of interest and areas of non-interest may be collected and stored for each social network account that opts into such features. Alternatively, users may opt out of such information being collected or stored. Based on the information indicating areas of interest and areas of non-interest, suggested content items and non-suggested content items may be identified for a particular social network account. A graphical user interface for the particular social network account may be displayed to the user of the account, and the graphical user interface may include information on the non-suggested content items and/or an option that allows the user to view information on the non-suggested content items. The graphical user interface may also include information on the suggested content items. As the user interacts with the graphical user interface, feedback data regarding the user's interest in one or more of the non-suggested content items may be collected and stored.

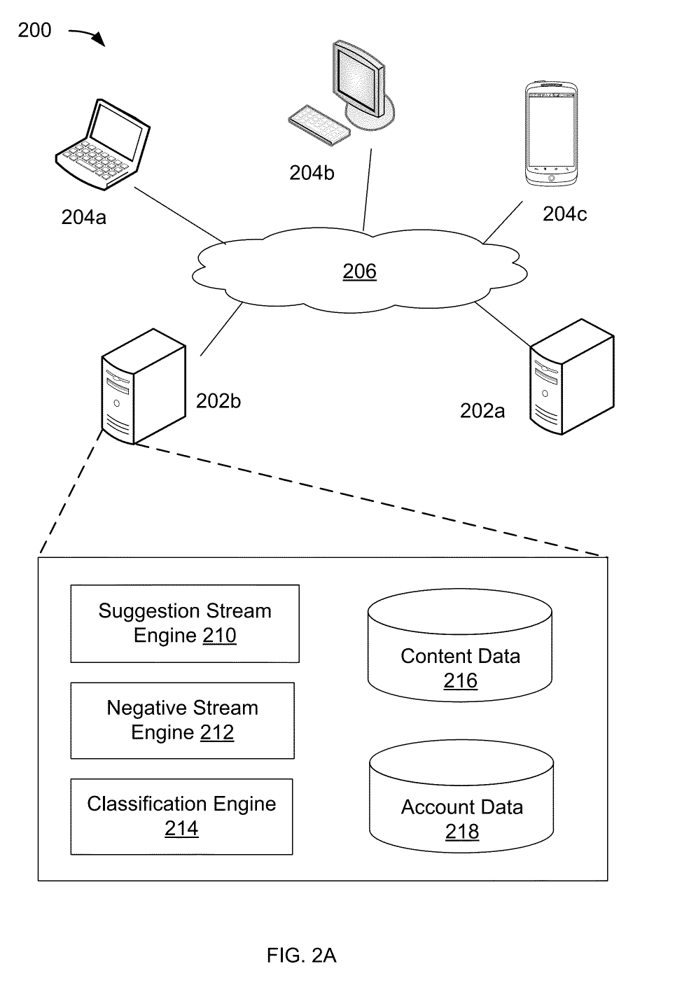

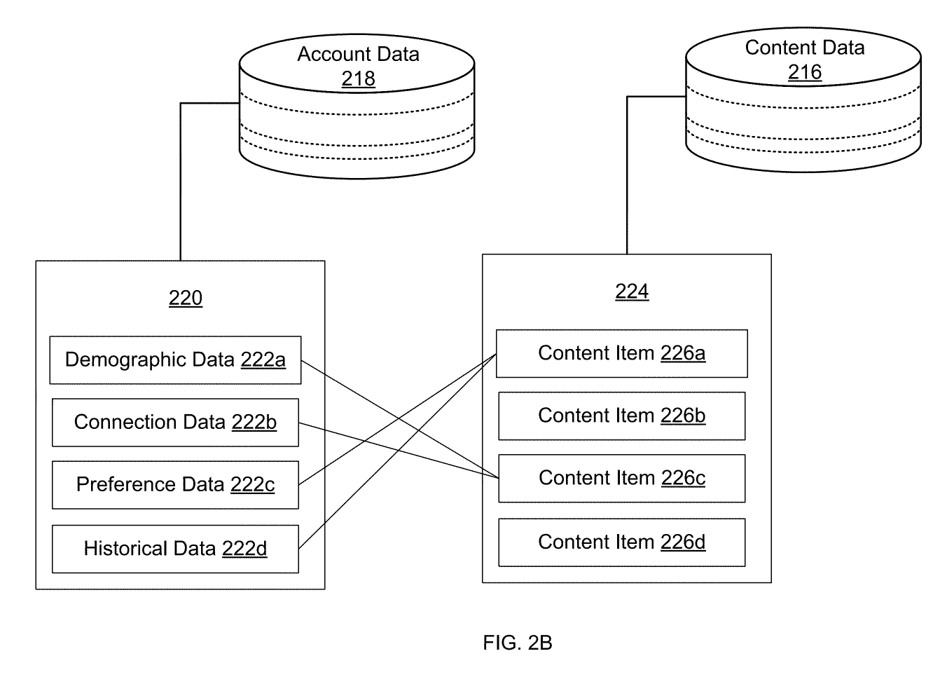

FIG. 2A is a schematic diagram of an example computing system 200 that can be used to implement aspects of a social network. For example, the computing system 200 may be used to implement the social network 100 in FIG. 1. Computing hardware and/or software used to implement a social network may include servers, databases, software, and/or other types of components distributed across one or more regions of the world. The example computing system 200 shown in FIG. 2 includes a social network server 202a, a content server 202b (collectively “servers 202”), client devices 204a, 204b, 204c (collectively “client devices 204”), and a network 206. The computing system 200 may include fewer, additional and/or different features and components that may be arranged and/or function in the same or a different manner than what is shown and described.

Generally, the servers 202 are electronic computing devices operable to receive, transmit, process, and store data associated with a social network. One or more of the servers 202 may be configured as a web server, a database, and/or another configuration. Although FIG. 2 illustrates two servers 202a, 202b the system 200 can be implemented using a different number of servers, including server clusters, as well as additional and/or different types of computing devices other than servers. The servers 202 may include any computer or processing device such as, for example, a blade server, a general-purpose personal computer (PC), a Mac server, a workstation, a Unix-based computer, or any other suitable device. Servers 202 may be adapted to execute any operating system including Linux, UNIX, Windows Server, and/or any other suitable operating system.

The servers 202 each include a data storage medium and data processing apparatus. The data storage medium stores information relating to the social network, and possibly other data. The stored data and/or pointers thereto may be stored in one or more tables in a relational database described in terms of SQL statements or scripts. The data may be formatted, stored, and/or defined as various data structures in text files, eXtensible Markup Language (XML) documents, Virtual Storage Access Method (VSAM) files, flat files, Btrieve files, comma-separated-value (CSV) files, internal variables, one or more libraries, and/or others. The data processing apparatus of each server 202 may include any suitable hardware, software, or firmware for carrying out data processing operations relating to the social network, and possibly other types of operations. The data processing apparatus may be implemented, for example, as a microprocessor executing software.

The content server 202b includes content data 216, account data 218, a suggestion stream engine 210, a negative stream engine 212, and a user classification engine 214. The content data 216 and the account data 218 are shown in FIG. 2B, which is a schematic diagram of example data relating to the social network.

The content data 216 includes information on content items that are available to one or more social network accounts in the social network. For example, the content data 216 may include a database of Internet content items, public entries, shared items, and/or other types of content items posted to the social network accounts and/or otherwise accessible through a social network account. The database may indicate an address (e.g., a Uniform Resource Locator, a Uniform Resource Name, etc.), a snippet or short text description, a thumbnail or other type or preview, a user rating, and/or other types of information about each content item. The database may include an identification of one or more content categories for each content item. In some examples, each content item may be categorized according to its format (e.g., image, video, text, multimedia, audio), its subject matter (e.g., baseball, gardening, education, gaming, etc.), its size (e.g., in kilobytes, megabytes, etc.), its age (e.g., in hours, days, weeks, etc.), demographic information on users that have expressed interest in the content item, and/or other types of categories. Content categories may include mutually exclusive categories, mutually inclusive categories, or combinations of these. Mutually inclusive content categories may overlap, so that a content item may fall into multiple different mutually inclusive content categories. Mutually exclusive content categories may require that a content item fall into only one of the mutually exclusive content categories. A content category may be mutually exclusive with respect to some content categories and mutually inclusive with respect to other content categories. The content data 216 may be updated over time. For example, the content data may be updated periodically or based on designated events. In FIG. 2B, the content data 216 includes a subset 224 of four content items 226a, 226b, 226c, 226d. Generally, the content data 216 may include information on hundreds, thousand, millions, or more content items.

The account data 218 includes information on social network accounts in the social network. For example, the account data 218 may include a database of social network accounts and information about each account. As shown in FIG. 2B, the database may include a subset 220 of data for a particular social network account. Users may select or decline the option of having such information stored for their individual account. The subset 220 for the particular account may include demographic data 222a, social network connection data 222b, preference data 222c, historical data 222d, and/or other types of information for the social network account. Demographic data 222a may include information about the user's personal background. For example, demographic data 222a may include the user's age, gender, location, occupation, marital or dating status, education, and/or other types of information. Users may opt out of having the social network store demographic data for their account. Connection data 222b may include information about the social network account's connections in the social network. For example, the connection data 222b may include information about the neighbors, friends, followers, links, and/or other types of connections that the social network account has established. Users may opt out of having the social network store connection data for their account. Historical data 222d may include information on the social network account's history. For example, the historical data 222d may include a history of content items viewed or accessed by the user, a history of content items posted to the account, a history of websites visited, a history of messages sent, a history of status updates, a history of login times, a history of IP addresses, a history of social network account connections, and/or other types of historical data. Users may opt out of having the social network store historical data for their account.

Preference data 222c may include information about categories of preferred content and categories of non-preferred content, or areas of interest and areas of non-interest, for the social network account. For example, the preference data 222c may include an identification of content sources (e.g., particular websites, particular social network accounts, etc.), content formats (e.g., images, articles, videos, etc.), content subject matter (e.g., sports, financial data, celebrity gossip, music, etc.), and/or other content item classifications in which the user of a social network account has directly, indirectly, or otherwise indicated an interest. The preference data 222c may indicate certain types of content that the user of a social network account is interested in, and the preference data may indicate certain types of content that the user is not interested in. The preference data 222c may be based on areas of interest or non-interest that were explicitly selected by the user and/or areas of interest or non-interest that were implicitly indicated by the user's actions. The account data 218 may be updated and/or modified over time. For example, a user may manually make changes to the account data and/or the account data may be automatically updated based on events and actions in the social network. Users may opt out of having the social network store preference data for their account.

The classification engine 214 can identify categories of preferred content and non-preferred content, or areas of interest and areas of non-interest, for a social network account. For example, the classification engine 214 may generate and/or modify the preference data 222c. The classification engine 214 may identify categories of preferred content and non-preferred content, or areas of interest and areas of non-interest, for a social network account based on the account's demographic data 222a, the account's connection data 222b, the account's historical data 222d, based on user feedback provided in response to suggested and/or non-suggested content items, and/or based on other types of information. The classification engine 214 may identify categories of preferred content and non-preferred content, or areas of interest and areas of non-interest, for a social network account based on preference data for other social network accounts, based on actions taken by other social network accounts, and/or based on other events in the social network.

The suggestion stream engine 210 can identify content items to suggest to the user of a social network account, for example, when the user has opted into such features. For example, the suggestion stream engine 210 may select one or more content items from the content data 216, and the content items may be selected based on the account data 218 for a particular account. The suggested content items may be selected based on ranking the content items according to the user's preferences and/or other criteria. The suggested content items may be selected based on matching content items to preferred categories of content or areas of interest for an account. The suggestion stream engine 210 may identify the suggested content items in another manner and/or based on other types of information. Information on the suggested content items identified by the suggestion stream engine 210 may be included in a graphical user interface presented to the user of the social network account. For example, the social network server 202a may incorporate the suggested content items into an account page that is generated and delivered to the user's client device 204 over the network 206.

In the example shown in FIG. 2B, content items 226a and 226c are identified by the suggestion stream engine 210 for suggestion to a user of a particular social network account. As indicated by the connecting lines in FIG. 2B, content item 226a is identified for suggestion to the particular account based on the preference data 222c and the historical data 222d for the particular account. For example, the content item 226a may relate to a particular hobby (e.g., gardening, cycling, etc.) identified in the preference data 222c, and the content item 226a may have been posted by another account frequently viewed by the user of the particular account (according to the history data 222d). As indicated by the connecting lines in FIG. 2B, content item 226c is identified for suggestion to the particular account based on the demographic data 222a and the connection data 222b for the particular account. For example, the content item 226c may relate to the user's location identified in the demographic data 222a, and the content item 226c may have been recently viewed another account identified in the connection data 222b.

The negative stream engine 212 can identify content items that are not suggested to the user of a social network account. For example, the negative stream engine 212 may select one or more content items represented in the content data 216 that were not selected by the suggestion stream engine 210. The non-suggested content items may be selected based on ranking the content items according to the user's preferences (e.g., selecting low-ranked items) and/or other criteria. The suggested content items may be selected based on matching content items to non-preferred categories of content or areas of non-interest for an account. The negative stream engine 212 may identify the non-suggested content items in another manner and/or based on other types of information. Information on the non-suggested content items identified by the negative stream engine 212 may be included in a graphical user interface presented to the user of the social network account. For example, the social network server 202a may incorporate a preview, description, or link for the non-suggested content items into an account page that is generated and delivered to the user's client device 204 over the network 206. In the example shown in FIG. 2B, content items 226b and 226d are available content items that were not identified by the suggestion stream engine 210 for suggestion to the user. As such, in this example, the negative stream engine 212 may identify either or both of the content items 226b, 226d as non-suggested content items.

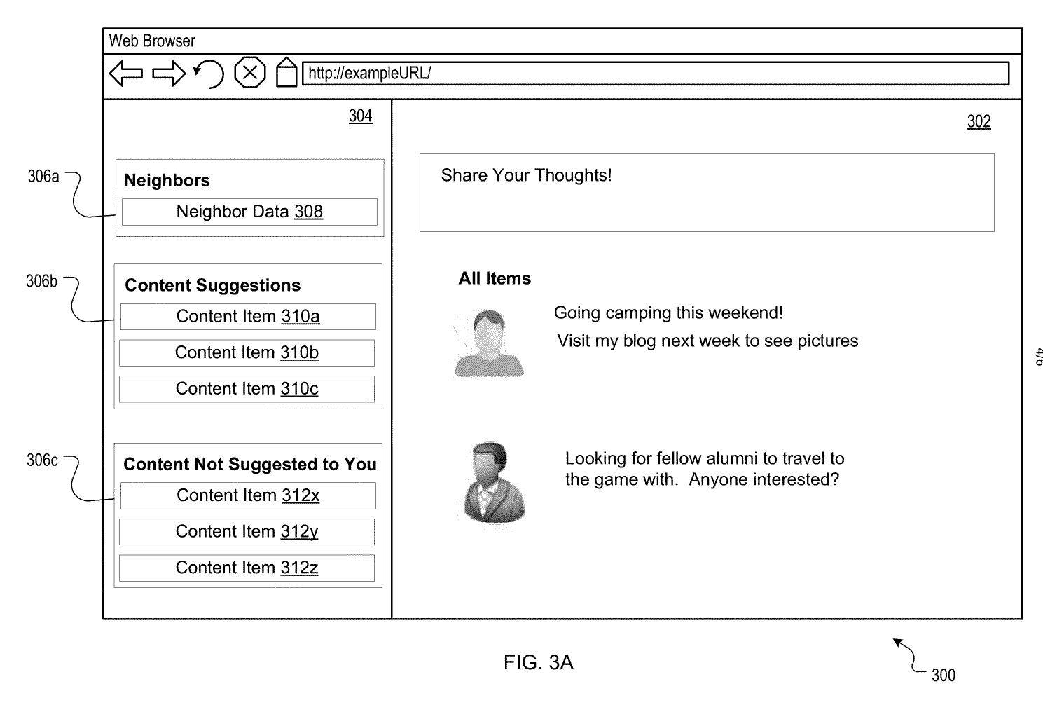

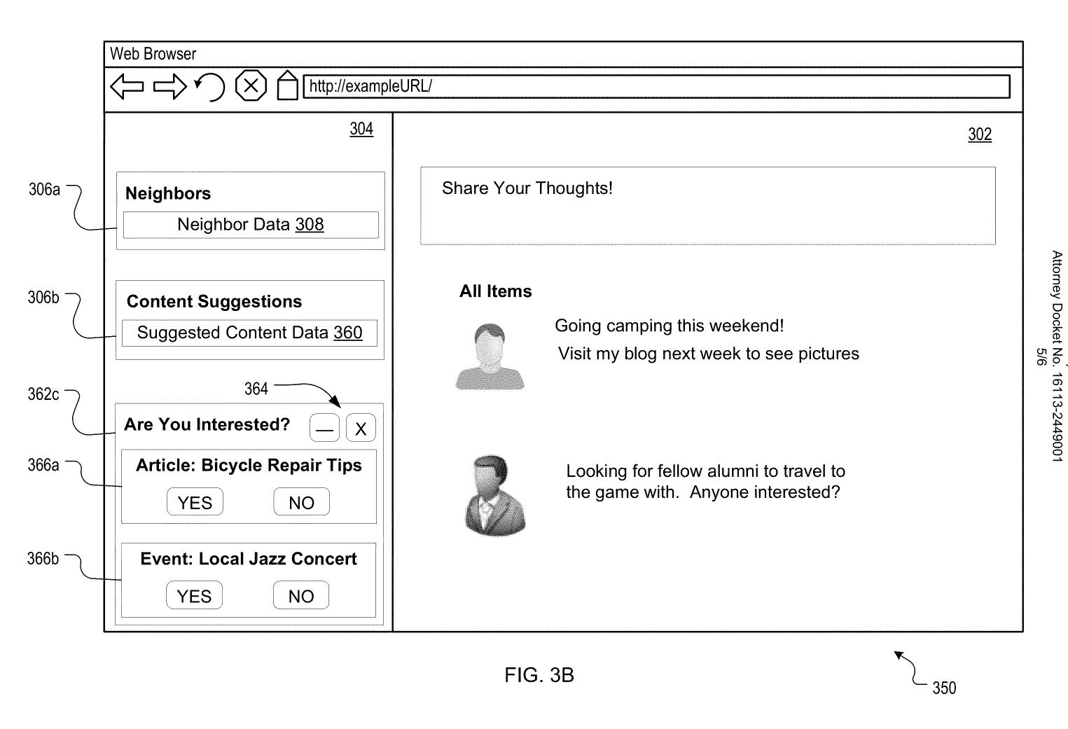

The social network server 202a provides users access to the social network. For example, the users may log on to the social network through client devices 204 connected to the network 206, and the social network server 202a may provide social network data to the client devices 204. The social network data may include browser or application content that can be rendered on the client devices 204. The content may include a social network user interface that allows the user to interact with the social network. The user interface may include information on suggested and/or non-suggested content items. For example, the account pages 300, 350 shown in FIGS. 3A, 3B, respectively, may be provided to one or more of the client devices 204 by the social network server 202c. The social network server 202a may receive data from the client devices 204, for example, through the social network user interface rendered on the client devices 204. In some instances, the social network server 202a may receive messages, requests, and/or other types of data that are transmitted to other social network accounts.

The client devices 204 are electronic computing devices operable to receive, transmit, process, and store data associated with a social network. The electronic computing devices may include laptop computers 204a, personal computers 204b, handheld devices 204c, and any other suitable computing device that can access the network 206. The client devices 204 may include browser applications that render social network content provided by the social network server 202a. The client devices 204 may include social network applications that render social network content provided by the social network server 202c. The client devices 204 include a data storage medium and data processing apparatus. The client devices 204 may store data and execute instructions relating to an individual user's client-side activity on the social network. For example, each user device is typically associated with a particular user who accesses the social network through a particular social network account. The user may enter a user ID, a password, and/or other identifying information at the client device 204 to gain access to the social network account. Once the user has gained access to an account, the client device renders a social network user interface, such as the account pages 300, 350 shown in FIGS. 3A, 3B, respectively, which allow the user to interact with other accounts in the social network.

The network 206 facilitates wireless and/or wireline communication among the computing devices in the system 200, including communications between the social network server 202a and any other local or remote computer, such as the clients 204 and/or the content server 202b. Wireless links may include, for example, 802.11 standards, cellular, GSM, CDMA, and/or others. Typically, the network 206 includes a public network, such as the Internet, that allows the clients 204 to access the social network server 202a from diverse locations. The network 206 may include a secured network. The network 206 may include a virtual private network (VPN) among one or more of the computing devices shown. Although shown as a single or continuous network, the network 206 may be logically divided into various sub-networks. In other words, the network 206 may encompasses any internal or external network, networks, sub-network, or combinations thereof. The network 206 may communicate, for example, Internet Protocol (IP) packets, Frame Relay frames, Asynchronous Transfer Mode (ATM) cells, voice, video, data, and other suitable information between network addresses. The network 206 may include one or more local area networks (LANs), radio access networks (RANs), metropolitan area networks (MANs), wide area networks (WANs), all or a portion of the global computer network known as the Internet, and/or any other communication system or systems at one or more locations.

A social network may present different pages and/or interfaces associated with each user, depending on the identity of the user. For example, a user can have a personal user account page that is presented only to that user when he or she is logged in using the user's credentials; a close neighbors page that is presented to a selected subset of other users connected to the user; a neighbors page that is viewable by all neighbors of the user; a public page that is viewable by anyone on the social network; and possibly other pages. The techniques of this invention can be used for one or more of the various pages. For example, the user can be presented on his or her personal page with non-suggested items that could be included on a page that one or more other users can view.

FIGS. 3A and 3B are diagrams of example account pages 300, 350 that present a graphical user interface for a particular account in a social network. For example, the account pages 300, 350 may include a user interface that allows a user associated with one of the social network accounts represented in FIG. 1 to interact with the social network 100. The account pages 300, 350 may be transmitted to a client device by a web server, such as, for example, the social network server 202a in the example computing system 200 shown in FIG. 2. A client device, such as the client devices 204a, 204a, 204c in FIG. 2, may receive the account pages 300, 350 over a data communication network and render the content for presentation on a display device. A user of the client device may interact with the social network through the user interface provided in the account pages 300, 350.

The example account pages 300, 350 shown in FIGS. 3A, 3B, respectively, are associated with a particular account in the social network. For example, the account pages 300, 350 may be configured, formatted, and/or otherwise adapted for one or more of the individual accounts 102 or organization accounts 106 in the social network 100 in FIG. 1. As such, the data presented in the account pages 300, 350 may include information and/or components individualized for a particular social network account. Such information may include, for example, a user name associated with the account, a representative image or avatar for the account, a list of social network connections for the account, updates from neighbors in the social network, recommended links and/or content for the account, and/or other types of information that the user has requested for display.

The example account pages 300, 350 includes two example user interface panes 302 and 304. The account pages 300, 350 may include fewer, additional and/or different features and components that may be arranged and/or function in the same or a different manner than what is shown and described. For example, the account pages 300, 350 may include additional and/or different user interface panes that present different types of information. The account pages 300, 350 may include machine code and/or code written in any language that can be interpreted by a browser or social network application that renders the account pages 300, 350. In some examples, the web page includes code written in any combination of markup languages (e.g., hyper-text markup language, extensible markup language, and/or others), scripting languages (JavaScript, ECMAscript, and/or others) and/or other types of languages.

The user interface pane 302 presents an example messaging interface for the particular social network account. The example messaging interface displays messages posted by other social network accounts, and/or allows the user of the particular account to post messages that can be viewed by other social network accounts. The particular account has connections in the social network with neighbor accounts. The messages posted by the particular account in the messaging interface may be viewable by the neighbor accounts, and/or the messages displayed in the messaging interface may include messages published by one or more of the neighbor accounts.

The user interface pane 304 presents multiple user interface components that may be used to access and/or navigate features of the social network. Generally, user interface components may include different areas, views, panes, modules, or regions in a user interface. In some instances, the user interface components are presented in separate frames or windows, which may be divided by borders, boxes, spacing, and/or other visual delimiters. The example user interface pane 304 shown in FIG. 3A includes a first user interface component 306a, a second user interface component 306b, and a third user interface component 306c. The user interface components 306a, 306b, 306c do not represent an exhaustive list of components that may be included in the social network user interface. For example, a graphical user interface for a social network account may include fewer, additional and/or different types of user interface components.

The user interface component 306a presents neighbor data 308, which includes information relating to neighbor accounts for the particular account. The neighbor accounts include other social network accounts with which the particular account shares a connection in the social network. In some cases, the neighbor data 308 includes a list of accounts that are currently online and/or other types of information. As a particular example, if the account page 300 were configured for the individual account 102a in FIG. 1, the neighbor data 308 in the user interface component 306a may include information on one or more of the accounts 102c, 106a, 102h, 106b, and 102g with which the individual account 102a shares a connection in the social network 100.

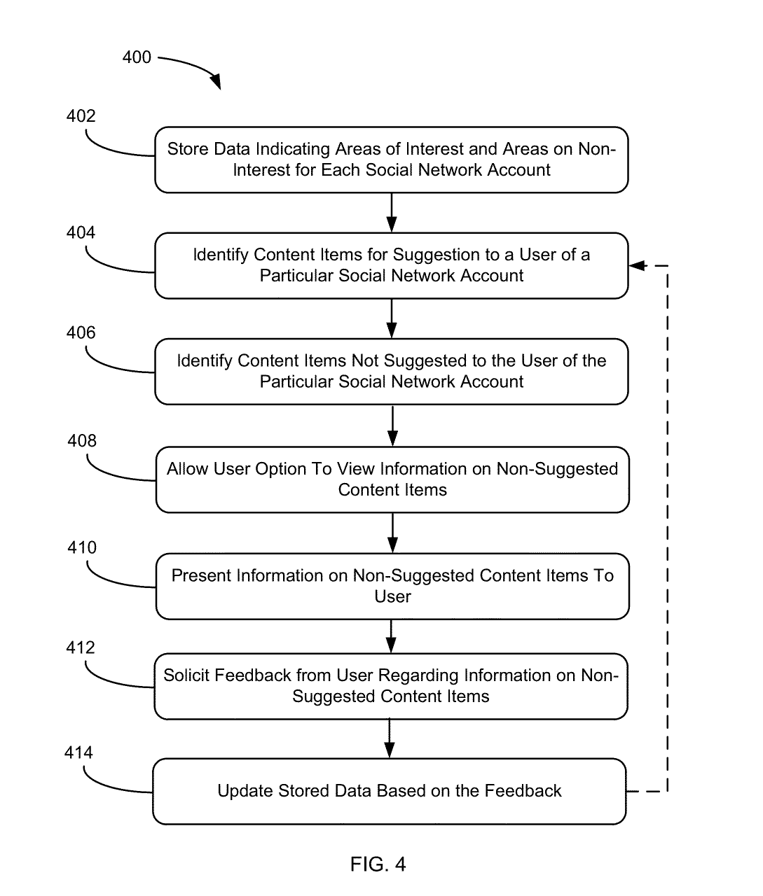

The user interface component 306b presents information on suggested content items for the particular social network account associated with the account page 300. For example, the user interface component 306b may include a list of Internet links, entries posted by other accounts, information on announcements or events, and/or other types of data that corresponds to preferred categories of content or areas of interest for the particular social network account. The suggested content items listed in the user interface component 306b may include, for example, the suggested content items identified in the process 400 shown in FIG. 4. Generally, any number of content items may be suggested to the user. In the example shown in FIG. 3A, the user interface component 306b presents information on three content items—content item 310a, content item 310b, and content item 310c. The information presented in the user interface component 306b may include a link, preview, description, or other information relating to the content item, rather than the content item itself The suggested content items 310a, 310b, 310c presented in the user interface component 306b are labeled “Content Suggestions” to indicate that the items listed have been identified as items that the user is likely to be interested in.

The user interface component 306c presents information on non-suggested content items for the particular social network account associated with the account page 300. For example, the user interface component 306b may include a list of Internet links, entries posted by other accounts, information on announcements or events, and/or other types of data that corresponds to non-preferred categories of content or areas of non-interest for the particular social network account. The non-suggested content items listed in the user interface component 306b may include, for example, the non-suggested content items identified in the process 400 shown in FIG. 4. Generally, any number of non-suggested content items may be listed in the user interface component 306c. In the example shown in FIG. 3A, the user interface component 306c presents information on three content items—content item 312x, content item 312y, and content item 312z. The information presented in the user interface component 306c may include a link, preview, description, or other information relating to the content item, rather than the content item itself. The information associated with the non-suggested content items 312x, 312y, 312z presented in the user interface component 306c is labeled “Content Not Suggested to You” to indicate that the items listed therein have been identified as items that the user is not likely to be interested in.

The user interface module 306c may be configured to detect a user interaction with the listed information. For example, the user interface module 306c may detect the user giving focus to, selecting, and/or otherwise interacting with the user interface module 306c in response to the presentation of information on the non-suggested content items 312x, 312y, 312z. User feedback data may be generated based on the user's interaction with the user interface module 306c, for example, a user's interaction with the interface module 306c in response to the presentation of information on the non-suggested content items 312x, 312y, 312z.

The example user interface pane 304 shown in FIG. 3B includes the first user interface component 306a that presents the neighbor data 308, the second user interface component 306b that presents suggested content data 360 (which may include, for example, links, previews, and/or other information on suggested content items), and a third user interface component 362c that presents information on non-suggested content items 366a, 366b. In the example account page 350 shown in FIG. 3B, the third user interface component 362c solicits user feedback in response to the presented information on non-suggested content items. As in FIG. 3A, the non-suggested content items in FIG. 3B are presented in a separate region of the interface from the suggested content items. The user interface component 362c includes toggle switches 364 that allow the user to opt to either view or not view the non-suggested content items. By interacting with the toggle switches 364, the user may request that non-suggested content items 366a, 366b be displayed, or the user may request that non-suggested content items 366a, 366b not be displayed.

The information about the non-suggested content items 366a, 366b is presented with interest level indicators that allow the user to indicate his or her level of interest in one or both of the non-suggested content items 366a, 366b. For example, the user may select the “YES” button for the non-suggested content item 366a to indicate interest in the article on bicycle repair tips, or the user may select the “NO” button for the non-suggested content item 366a to indicate lack of interest in the article on bicycle repair tips. Similarly, the user may select the “YES” button for the non-suggested content item 366b to indicate interest in the local jazz concert event, or the user may select the “NO” button for the non-suggested content item 366b to indicate lack of interest in the local jazz concert event. Generally, any number (e.g., one, two, three, four, etc.) of interest level indicators and/or other types of information may be presented to solicit user feedback on non-suggested content items.

FIG. 4 is a flow chart showing an example process 400 for allowing a user to view non-suggested content items in a social network. The process 400 may be used to present both suggested and non-suggested content items to a social network user. In some instances, the process 400 is used to collect feedback from a user regarding the user's interest in non-suggested content items. For example, in the context of the social network 100 shown in FIG. 1, the process 400 may be used to display information on non-suggested content items to a user of the individual account 102a and to collect feedback from the user based on the displayed information. Users may select or decline an option to have their preferences and/or areas of interest identified. Users may select or decline an option to have content items suggested to them based on their preferences and/or areas of interest.

One or more operations in the process 400 may be carried out by components of a computing system, such as the system 200 shown in FIG. 2A. In some implementations, the process 400 may be carried out by one or more servers interacting with clients over a data network. In some implementations, one or more operations associated with the process 400 may be carried out at the client device (e.g., displaying data to a user, receiving data from the user, detecting user interactions). The process 400 may include fewer, additional, or different operations performed in the same order or a different order than what is shown. In some implementations, one or more of the operations in the process 400 may be repeated, iterated, or modified as appropriate. Moreover, individual operations or subsets of the operations may be carried out as a separate process and/or in connection with other types of processes.

At 402, data that indicates areas of interest and areas of non-interest for each social network account are stored. The data may be stored on computer-readable storage media in one or more locations representing one or more databases. The data may indicate preferred categories of content and non-preferred categories of content associated with a particular social network account. The data may explicitly identify categories of content or other indicators of content types in which a user of a particular social network account has expressed interest; and/or the data may explicitly identify categories of content or other indicators of content types in which a user of a particular social network account has expressed disinterest. In some cases, the data does not include an explicit identification of such preferred or non-preferred categories of content. For example, the data may include information (e.g., demographic data, neighbor data, links, history data, etc.) from which preferred and non-preferred categories of content, or areas of interest and non-interest, may be identified. As such, preferred and non-preferred categories of content, or areas of interest and non-interest, may be directly or indirectly indicated by the stored data.

At 404, content items for suggestion to a user of a particular social network account are identified. The content items may include content published by a different social network account and/or content published outside the social network. The content items may include, for example, shared links, photos, videos, updates, articles, and/or other types of content items. The content items may be identified from all content items that are available to be viewed by the particular social network account. For example, the content items may be selected from a list of pubic entries in the social network, a list of shared entries in the social network, a list of Internet content items, a list of social network features, and/or a combination of these and/or other types of data. The suggested content items may be identified based on the stored data indicating areas of interest for the particular social network account. In some implementations, the content items for suggestion to the particular social network account are identified by ranking multiple available content items and selecting highly-ranked content items, which may include only the top-ranked content items.

In some implementations, the suggested content items are presented to the user of the particular social network account. For example, when the user logs onto the particular social network account at a client device, the account page displayed to the user may include an identification of (e.g., a preview of, a description of, and/or a link to) each of the suggested content items.

At 406, content items not suggested to the user of the particular social network account are identified. The non-suggested content items may be identified based on the data indicating areas of non-interest, or the non-preferred categories of content, for the particular social network account. For example, the non-suggested content items may include content items that the stored data indicates the user would not be interested in. As such, the non-suggested content items may include content items that would ordinarily not be displayed to the user due to a presumption (based on stored data) that the user will not be interested in the content items.

In some cases, for example where the suggested content items are identified by ranking multiple available content items, the non-suggested content items may be identified from the ranking For example, the non-suggested content items identified at 406 may include the lowest-ranked content items or a subset of low-ranking content items. The non-suggested content items may include available content items ranked below (e.g., just below, far below, etc.) the suggested content items in the ranking In cases where such rankings are used, the available content items may be ranked according to any type of criteria. For example, the available content items may be ranked according to popularity in the social network, according to the particular user's preferences and interest, and/or according to other criteria.

In some implementations, the suggested content items (identified at 404) and the non-suggested content items (identified at 406) are two non-overlapping subsets of the available content items. Data stored by the social network may indicate that the suggested content items are ones that the user is more likely (or most likely) to be interested in and that the non-suggested content items are ones that the user is less likely (or least likely) to be interested in. In some instances, the non-suggested content items may include content items that are popular among other users but not expected to be of interest to the user of the particular account. For example, public entries may be divided into categories, and popular public entries in categories the user is not interest in may be selected as non-suggested content items.

At 408, a user of the particular social network account is given the option to view the non-suggested content items. For example, the user's account page may include a module or a link that, when selected by the user, causes an identification of (e.g., a preview of, a description of, and/or a link to) each of the non-suggested content items to appear. The option to view the non-suggested content item may be provided in a graphical user interface displayed to the user. The graphical user interface may additionally include a listing of or an option to view a listing of the suggested content items. The suggested content items and the option to view the non-suggested content items may be presented in separate modules in the graphical user interface or in the same module.

After giving the user the option to view the non-suggested content items, a user interaction may be detected. The user interaction may indicate a request by the user to view the non-suggested content items. For example, the user may select a link or interact with a module that asks the user if he or she wants to view the non-suggested content items. In some implementations, the user selects the link or otherwise interacts with the user interface, for example, by giving focus to the link or module with a pointing device (e.g., a touch screen, a mouse, a stylus, etc.). In some instances, the user's selection may indicate that the user has declined the option to view the non-suggested content items. In some instances, the user's selection may indicate that the user would like to view the non-suggested content items.

At 410, information on the non-suggested content items is presented to the user of the particular social network account. For example, the non-suggested content items may be presented based on detection of a user interaction with a user interface module. The user interaction may correspond to a user's request to view the non-suggested content items. In some instances, the non-suggested content items may be displayed independent of a user request. The non-suggested content items may be presented as an identification of (e.g., a preview of, a description of, and/or a link to) each of the non-suggested content. The non-suggested content items may be presented with an explanation or reason why the content items were not suggested. For example, if a non-suggested content item relates to country music, the information presented to the user may include an identification of the country music content item and text explaining that the user had previously declined content items relating country music. As another example, if a non-suggested content item relates to gardening, a message such as, “This item is currently not shown because you've expressed a dislike for material concerning: Gardening” may be displayed.

The non-suggested content items may be presented in a module of a graphical user interface for the particular user account. The non-suggested content items may be presented in a separate module from the suggested content items. In some instances, the suggested content items and the non-suggested content items may be presented together (e.g., merged/interleaved in a single module) with proper labels or other visual indicators to avoid confusion, for example, by clearly delineating which content items are suggested and which items are non-suggested. The non-suggested content items may be presented to the user along with a visual indication that the presented items correspond to non-preferred categories of content for the user and/or that the non-suggested content items are presumed to not be of interest to the user. For example, the non-suggested content items may be presented with text stating “Here's what we're not showing you,” or a similar message.

At 412, feedback regarding the information on the non-suggested content items is solicited from the user. For example, the non-suggested content items may be presented along with one or more interest level indicators that allow the user to indicate an interest level for each non-suggested content item. A user selection of one of the interest level indicators may indicate that the user is interested in the non-suggested content item, that the user is not interested in the non-suggested content item, that the user is impartial to the non-suggested content item, etc. To solicit feedback from the user, the non-suggested content item may be presented with a user prompt such as, for example, “Show me items like this,” “Move to suggested content list,” or a similar prompt. Thus, soliciting feedback from the user may include prompting the user to actively provide feedback and/or prompting the user to explicitly indicate whether she or he is interested in the non-suggested content item.

After soliciting feedback from the user regarding the non-suggested content items, feedback data may be received. The feedback data may indicate the user's level of interest in one or more of the non-suggested content items. For example, the feedback may be based on a detection of a user interaction with a user interface component that includes information on the non-suggested content items. The user interface component may include prompts and/or interest level indicators that actively solicit feedback from the user. In some cases, the feedback is received unsolicited. That is to say, the feedback may be received in response to the presentation of the non-suggested content items without any request for user feedback. For example, the user may comment on a non-suggested content item, share a non-suggested content item, select a link or request further information about a non-suggested content items, and such user interactions may indicate the user's level of interest in the non-suggested content item.

Generally, the feedback data may indicate any level of interest or non-interest in any one or more of the non-suggested content items. For example, user interactions that may indicate a low level of interest may include the user rejecting a preview of one of the non-suggested content items, the user selecting a low interest level indicator associated with the non-suggested content item, the user giving focus to but not selecting the non-suggested content items, and/or others. User interactions that may indicate a high level of interest may include the user requesting more information on one of the non-suggested content items, the user selecting a high interest level indicator associated with the non-suggested content item, the user following a link to view the non-suggested content items, and/or others. Moreover, these and/or other types of interactions may be weighted differently. For example, a higher interest level may be inferred from the user selecting an interest level indicator than would be inferred from the user viewing the content item. In some cases, the value of the feedback signal for a user interaction (e.g., read, like, comment, etc.) can be scaled up to reflect that a user interaction with a non-suggested content item may be considered a strong signal for a learning system. By providing a strong signal on an area of interest, prior data that indicated an area of non-interest for the user may be offset.

At 414, the stored data is updated based on the feedback. For example, the received feedback data may indicate an additional area of interest for the user of the particular social network account, or the received feedback data may indicate an additional area of non-interest for the user of the particular social network account. Updating the stored data may include storing the feedback data in a database with the stored social network data, modifying the stored social network data, providing the feedback data as input to a learning system, and/or other types of updates.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
storing social network account data indicating preferred categories of content associated with a particular social network account;
filtering a plurality of content items based on the preferred categories of content to identify i) a plurality of suggested content items and ii) a plurality of filtered content items that are exclusive of corresponding to the preferred categories of content;
identifying, by operation of a computer, one or more negative indicators for the particular social network account determined by a user's indication of non-interest in categories of content;
identifying, by operation of a computer, a subset of the plurality of filtered content items based on the one or more negative indicators to provide a plurality of non-suggested content items;
providing, by operation of a computer, a graphical user interface for presentation at a client device to a user of the particular social network account, the graphical user interface including:
a first user interface component that presents information about the suggested content items; and
a second user interface component that presents information about the non-suggested content items;
providing information for the second user interface, the information including an explanation as to why the non-suggested content items were not suggested;
receiving feedback data based on a detection of an indication of a user's interest in viewing a content item in a non-preferred category in response to a presentation of the information about the non-suggested content items in the second user interface component; and
updating the stored social network account data to modify, based on the feedback data, preference data associated with the one or more negative indicators to reflect the non-preferred category as a preferred category.

2. The method of claim 1, wherein the stored social network account data indicates the one or more negative indicators.

3. The method of claim 1, further including identifying that the feedback data indicates an area of interest for the user of the particular social network account.

4. The method of claim 1, further including identifying that the feedback data indicates an area of non-interest for the user of the particular social network account.

5. The method of claim 1, wherein updating the stored social network account data includes storing the feedback data in a database with the stored social network data.

6. The method of claim 1, wherein updating the stored social network account data includes modifying the stored social network data.

7. The method of claim 1, wherein updating the stored social network account data includes providing the feedback data as input to a learning system.

8. The method of claim 1, wherein the indication of the user's interest includes at least one of:
the user giving focus to the information about the content item;
the user requesting to view additional information about the content item; or
the user dismissing the information about the content item.

9. The method of claim 1, further including:
ranking a plurality of available content items according to the social network account data; and
wherein the plurality of suggested content items and the plurality of non-suggested content items are identified from the plurality of available content items based on the ranking.

10. The method of claim 1, wherein the suggested content items corresponds to multiple categories of content.

11. The method of claim 1, wherein the preferred categories include preferred subject matter categories that each correspond to a preferred type of subject matter.

12. A non-transitory computer storage medium encoded with a computer program, the program comprising instructions that when executed by data processing apparatus cause the data processing apparatus to perform operations comprising:
receiving social network account data that indicates areas of interest and areas of non-interest associated with a particular social network account;
receiving content data relating to a plurality of available content items;
filtering the plurality of available content items based on the areas of interest to identify i) a plurality of suggested content items and ii) a plurality of filtered content items that are exclusive of corresponding to the areas of interest;
identifying one or more negative indicators for the particular social network account based on the areas of non-interest;
identifying a subset of the plurality of filtered content items based on the one or more negative indicators to provide a plurality of non-suggested content items;
providing a graphical user interface for presentation at a client device to a user of the particular social network account, the graphical user interface including:
a first user interface component that presents information about the suggested content items; and
a second user interface component that allows the user to view information about one or more of the non-suggested content items;
providing information for the second user interface, the information including an explanation as to why the non-suggested content items were not suggested;
receiving feedback data based on a detection of an indication of a user's interest in viewing a content item in a non-preferred category in response to a presentation of the information about the non-suggested content items in the second user interface component, the non-preferred category determined by a user's indication of non-interest in a category; and
updating the stored social network account data to modify, based on the feedback data, preference data associated with the one or more negative indicators to reflect the non-preferred category as a preferred category.

13. The computer storage medium of claim 12, wherein one or more of the available content items includes a public entry associated with a second, different social network account.

14. The computer storage medium of claim 13, wherein the public entry includes at least one of a shared link, a photo, a video, or an update.

15. The computer storage medium of claim 12, wherein the second user interface component presents the information about the non-suggested content items based on a detection of a user interaction with the second user interface component.

16. (canceled)

17. A system comprising:
a database storing data that indicates preferred categories of content and non-preferred categories of content associated with a particular social network account; and
a server configured to:
filter a plurality of content items based on the preferred categories of content to identify i) a plurality of suggested content items corresponding to the preferred categories of content for the particular social network account and ii) a plurality of filtered content items that are exclusive of corresponding to the preferred categories of content;
identify one or more negative indicators for the particular social network account based on the non-preferred categories of content;
identify a subset of the plurality of filtered content items based on the one or more negative indicators to provide a plurality of non-suggested content items;
provide a graphical user interface for presentation at a client device to a user of the particular social network account, the graphical user interface including a user interface component that presents information about the plurality of non-suggested content items and solicits user feedback on the information about the plurality of non-suggested content items;
provide information for the second user interface, the information including an explanation as to why the non-suggested content items were not suggested; and
receive feedback data based on a detection of an indication of a user's interest in viewing a content item in a non-preferred category in response to a presentation of the information about the non-suggested content items in the user interface component; and
update the stored social network account data to modify, based on the feedback data, preference data associated with the one or more negative indicators to reflect the non-preferred category as a preferred category.

18. The system of claim 17, wherein the user interface component solicits user feedback by presenting a plurality of interest level indicators that allow the user to indicate an interest level for one or more of the non-suggested content items, and the indication of a user's interest includes a user selection of one of the interest level indicators.

19. The system of claim 17, wherein the feedback data indicates that the user has a low level of interest in one of the non-suggested content items.

20. The system of claim 17, wherein the feedback data indicates that the user has a high level of interest in one of the non-suggested content items.

21. The system of claim 17, further including the client device.

22. The system of claim 21, further including a data communication network that transmits data between the client device and the server.

23. The system of claim 21, wherein the client device includes at least one of a personal computer or a mobile device running a browser.

24. The method of claim 1, further including determining the information provided for the second user interface based on prior direct user actions.

25. The method of claim 1, further including determining the information provided for the second user interface based on prior indirect user actions.

26. The method of claim 1, further including determining the information provided for the second user interface based on non-user-action-based deductions.

27. The medium of claim 12, further including instructions to determine the information provided for the second user interface based on prior direct user actions.

28. The medium of claim 12, further including instructions to determine the information provided for the second user interface based on prior indirect user actions.

29. The medium of claim 12, further including instructions to determine the information provided for the second user interface based on non-user-action-based deductions.

30. The system of claim 17, further configured to determine the information provided for the second user interface based on prior direct user actions.

31. The system of claim 17, further configured to determine the information provided for the second user interface based on prior indirect user actions.

32. The system of claim 17, further configured to determine the information presented in the second user interface based on non-user-action-based deductions.
